(19) United States
(12) Patent Application Publication
(10) Pub. No.: US 2014/0177558 A1
(43) Pub. Date: Jun. 26, 2014

(54) System and Methods for Almost Blank Subframe (ABS) Density and Range Extension Optimization in Heterogeneous Networks

(71) Applicant: FutureWei Technologies, Inc., Plano, TX (US)

(72) Inventors: Hossein Bagheri, Arlington Heights, IL (US); Peng Zhang, Shanghai (CN); Carmela Cozzo, San Diego, CA (US)

(21) Appl. No.: 14/135,140

(22) Filed: Dec. 19, 2013

Related U.S. Application Data
(60) Provisional application No. 61/740,275, filed on Dec. 20, 2012.

(51) Int. Cl. H04L 5/00; H04W 24/10

(52) U.S. Cl. CPC H04L 5/0058; H04W 24/10
USPC 370/329

(57) ABSTRACT

Embodiments are provided for optimizing the Almost Blank Subframe (ABS) pattern in heterogeneous network (HetNet) deployments with multiple small cells. One ABS pattern is used for all small cells. Different small cells can have different downlink loads from user equipments (UEs). An embodiment method includes transmitting a pilot signal in a small cell, and determining downlink load (DLL) information according to a pair of measurements from each UE served by the small cell. The pair of measurements includes a first measurement of the pilot signal and a second measurement of a second pilot signal from a macro cell. The method further includes determining a number of ABSs according to the DLL information, and reporting the DLL information and the number of ABSs to a network entity for selecting ABS density and range extension for the small cell and the macro cell.

This application claims the benefit of U.S. Provisional Application No. 61/740,275 filed on Dec. 20, 2012 by Hossein Bagheri et al. and entitled “System and Method for ABS Pattern Optimization in Heterogeneous Networks,” which is hereby incorporated herein by reference as if reproduced in its entirety.

### TECHNICAL FIELD

The present invention relates to the field of wireless communications, and, in particular embodiments, to system and methods for Almost Blank Subframe (ABS) density and range extension optimization in heterogeneous networks.

### BACKGROUND

Mobile data traffic is growing quickly and is expected to continue to grow due to the increasing penetration of smart phones and the increasing use of data and video services. Heterogeneous Networks (HetNets) are considered as a promising technology to meet the requirements in an efficient way and with a relatively low cost. A HetNet is a mixed deployment of macro cells and small cells. A small cell is also called a Low Power Node (LPN), and its use can be effective to quickly increase the capacity and coverage area of the network. In HetNet, the transmit power of the macro cell is typically higher than that of the small cell. When the cells are deployed on the same frequency, which is the co-channel scenario, typically one or more small cells are allowed to serve a user equipment (UE) if the small cells' signals at the UE have higher power than that of the macro cell. The coverage of the small cells can be extended by allowing the small cells to serve the UE even if the small cells' signals at the UE have less power than the macro cell's signal. However, this also causes interference on downlinks at the UE. Time slots can be allocated to restrict downlink transmissions from the macro cell and hence allow the UEs to receive on downlinks from the small cells with less or no interference. However, there is a need for an efficient scheme for selecting an appropriate number of time slots of restricted transmissions from the macro cell and providing suitable coverage range for the small cells while saving network resources.

### SUMMARY OF THE INVENTION

In accordance with an embodiment of the disclosure, a method by a network component in a small cell for determining Almost Blank Subframe (ABS) density and range extension value for small cells in a wireless network includes transmitting a pilot signal in the small cell, and determining downlink load (DLL) information according to a pair of measurements from each user equipment (UE) served by the small cell. The pair of measurements includes a first measurement of the pilot signal and a second measurement of a second pilot signal from a macro cell. The macro cell has a higher transmission power than the small cell. The method further includes determining a number of ABSs according to the DLL information, and reporting the DLL information and the number of ABSs to a network entity for selecting ABS density and range extension value for the small cell and the macro cell.

In accordance with another embodiment of the disclosure, a network component in a small cell for determining ABS density and range extension value for small cells in a wireless network includes at least one processor and a non-transitory computer readable storage medium storing programming for execution by the processor. The programming includes instructions to transmit a pilot signal in the small cell, and receive a pair of measurements from each UE served by the small cell. The pair of measurements includes a first measurement of the pilot signal and a second measurement of a second pilot signal from a macro cell. The macro cell has a higher transmission power than the small cell. The programming further includes instructions to determine DLL information according to the first measurement and the second measurement from each UE served by the small cell, and determine a number of ABSs according to the DLL information. The network component is further configured to report the DLL information and the number of ABSs to a network entity for selecting ABS density and range extension value for the small cell and the macro cell.

In accordance with another embodiment of the disclosure, a method by a network component in a macro cell for determining ABS density and range extension for small cells in a wireless network includes transmitting a pilot signal in the macro cell, and determining, for each small cell, DLL information according to receiving a pair of measurements from each UE served by each small cell considered in the wireless network. The pair of measurements includes a first measurement of the pilot signal and a second measurement of a second pilot signal from a small cell. The small cell has a lower transmission power than the macro cell. The method further includes determining, for each small cell, a number of ABSs according to the DLL information, and reporting the DLL information and the number of ABSs for each small cell to a network entity for selecting ABS density and range extension value for each small cell and the macro cell.

In accordance with yet another embodiment of the disclosure, a network component in a macro cell for determining ABS density and range extension value for small cells in a wireless network includes at least one processor and a non-transitory computer readable storage medium storing programming for execution by the processor. The programming includes instructions to transmit a pilot signal in the macro cell, and receive a pair of measurements from each UE served by each small cell considered in the wireless network. The pair of measurements includes a first measurement of the pilot signal and a second measurement of a second pilot signal from a small cell. The small cell has a lower transmission power than the macro cell. The programming includes further instructions to determine, for each small cell, DLL information according to the first measurement and the second measurement from each UE served by the small cell, and determine, for each small cell, a number of ABSs according to the DLL information. The network component is further configured to report the DLL information and the number of ABSs for each small cell to a network entity for selecting ABS density and range extension value for each small cell and the macro cell.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates a scenario of a heterogeneous network;

FIG. 2 illustrates an embodiment of a scheme for Almost Blank Subframe (ABS) density and Range Extension (RE) optimization in heterogeneous networks;

FIG. 3 illustrates an embodiment of a method for ABS density and RE optimization in heterogeneous networks; and

FIG. 4 is a diagram of a processing system that can be used to implement various embodiments.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The operation and structure of the presently preferred embodiments are discussed in detail below. It should be appreciated, however, that the present invention provides many applicable inventive concepts that can be embodied in a wide variety of specific contexts. The specific embodiments discussed are merely illustrative of specific structures and methods of the invention, and do not limit the scope of the invention.

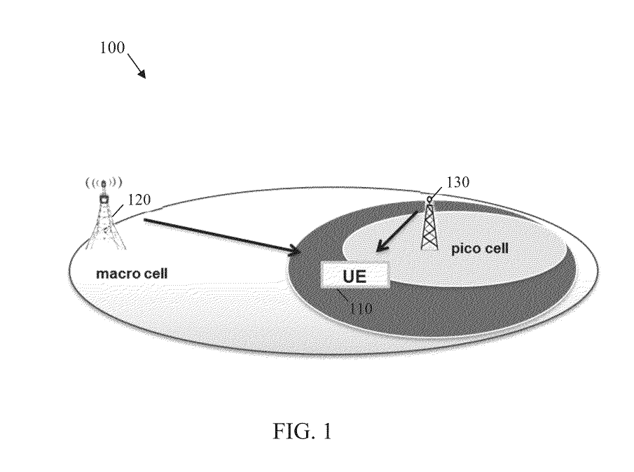

FIG. 1 illustrates a scenario of a heterogeneous network 100 where a UE 110 is served by two cells, a serving cell 120 and an assisting serving cell 130. The UE 110 can be a smartphone or any mobile user communications device. For instance, the serving cell 120 is a macro cell such as a NodeB, and the assisting serving cell 130 is a small or pico cell which is a radio node that has lower transmission power than the NodeB. The terms small cell and pico cell are used herein interchangeably to refer to low power radio nodes in comparison to the macro cell.

Range Extension (RE) is a technique to extend the coverage of the small cell in heterogeneous networks. In typical operations, a UE is served by the small cell only when the signal strength from the small cell received at the UE is larger than that from the macro cell. In RE operation, however, a UE can be served by the small cell even when the signal strength from the small cell received at the UE is smaller than that from the macro cell. Such RE UEs served by the small cell, however, can suffer from strong downlink interference due to the macro cell.

Almost blank subframe (ABS) operation can be used to reduce the downlink interference. A periodical pattern indicating ABSs (where transmission of the macro cell are restricted) and non-ABSs (where the macro cell transmissions are not restricted) is defined by the network. During ABSs, the macro cell restricts its data transmission to the UEs served by the macro. This results in reduced macro downlink interference to a UE served by the small cell with RE. The RE UE can be served by the small cell during ABSs. During non-ABSs, the macro cell has no restriction on its data transmission to the UE, and the small cell would only serve a non-RE UE. An example of an ABS pattern is 00011111, where ‘0’ indicates an ABS while ‘1’ indicates a non-ABS. For the first 3 subframes, the macro cell restricts its data transmission while for the last 5 subframes the macro cell resumes its data transmission.

Embodiments are provided herein for optimizing the ABS pattern in heterogeneous network (HetNet) deployments with multiple small or pico cells, e.g., inside a macro cell coverage. There is one ABS pattern used for all small cells while the small cells' load may be different. Different small cells may have different downlink loads, e.g., due to the difference in number of UEs or applications. There may be scenarios where a lightly loaded small cell receives a larger number of ABSs than what it needs. For example, a first small cell requires 3 ABSs and a second small cell requires 1 ABS. The network may assign 3 ABSs to satisfy the requested load from the first small cell, or 2 ABSs to make a compromise between the requests. However, the second small cell may find even the 2 ABSs more than what it needs due to its low load. The chosen number of ABSs for all small cells is referred to herein as ABS density.

In an embodiment, a radio network controller (RNC) is an entity of the network responsible for ABS density determination. If the RNC has more knowledge than aggregate downlink (DL) load information for each small cell, the RNC may be able to assign a better ABS density (a more suitable or optimal number of ABSs) considering requirement of all or multiple small cells and assign a better Cell RE (CRE) value for each small cell. The CRE reflects cell's coverage in accordance with RE operation. The CRE can be a cell-specific offset applied to UE measurements to enlarge the cell's coverage area. To make such ABS and CRE determinations, additional information is provided to the RNC, including multiple DL load (DLL) information corresponding to UEs present in potential RE areas of each small cell and corresponding recommended number of ABSs. The RNC uses this information to assign a better optimized ABS pattern to all small cells and a proper CRE value for each small cell.

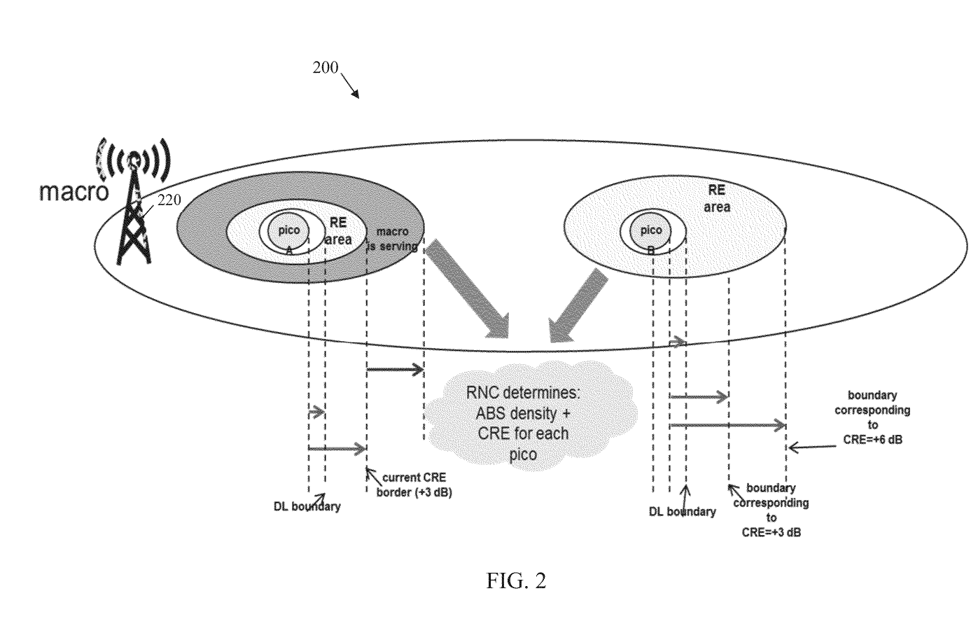

FIG. 2 shows an embodiment of a scheme 200 for ABS density and RE optimization than can be implemented for HetNets. According to the scheme 200, the RNC provides each considered pico cell with a set of possible or potential CRE values (referred to as a CRE set). An example of the CRE set is {−3, 0, 3, 6} in dBs. The CRE set can be different for different small or pico cells. For example, the pico cells closer to the macro cell base station 220, such as pico cell A, may have a different CRE set than pico cells that are farther from the macro base station 220, such as pico cell B. Alternatively, at least some of the pico cells may have the same CRE set.

In an embodiment, the RNC can trigger, e.g., using radio resource control (RRC) signaling, measurements at the cells for the purpose of determining ABS density. Thus, each small cell transmits a common pilot channel (CPICH) with a specified power, e.g., upon receiving the RRC signaling. Small cells closer to the macro cell may optionally transmit an additional pilot channel to CPICH to accommodate more pilot power to report measurements corresponding to larger CREs. The macro cell also transmits its CPICH for this purpose. For example, the measurements can be triggered by the RNC when a small cell signals the RNC to indicate that the small cell's DLL has changed (e.g., beyond a fluctuation threshold). Other measurement triggering mechanisms may also apply.

Each UE measures the macro CPICH power (referred to herein as macro CPICH EcNo) and the small or pico CPICH power of its small or pico cell (referred to herein as small cell CPICH EcNo), and reports this measurements pair (MP) to its serving cell/radio node (pico or macro). In an embodiment, each UE sends the MP to its serving cell. The ID of the non-serving cell can be included in the report to the serving cell. The reporting can be done using higher layer signaling. In another embodiment, the reporting is done using physical layer signaling. For instance, the Channel Quality Indication (CQI) field in the high speed dedicated physical control channel (HS-DPCCH) can be used for this report. The dual-cell (DC) CQI format can be reused in a reporting period to send the MP to the serving cell. The DC CQI format carries the CQI for the serving cell and non-serving cell of the UE. The UE can repeat the transmission of the CQI report containing the CPICH power for the serving cell over the next defined number (as indicated by a parameter N_MP_transmit) of consecutive HS-DPCCH subframes in the slots respectively allocated to the CQI. The UE can also transmit the CQI for the other cell involved in the MP over the next defined number of consecutive HS-DPCCH subframes immediately following the transmission of the CQI report containing the CPICH power for the serving cell. The parameter N_MP_transmit and the power of the HS-DPCCH can be set to ensure the reliability of the report. To transmit the ID of the non-serving cell to the serving cell, the unused Precoding Matrix Indicator (PMI)/Rank Indicator (RI) field bits (e.g., 64 IDs can be supported with 4-branch multiple-input and multiple-output (MIMO) report) in the dual-cell CQI report can be reused even if the UE is not configured in the MIMO mode. This special dual-cell CQI report can be reused for the purpose of the MP report. The hybrid automatic repeat request (HARM) field of HS-DPCCH can also be used if more than 64 IDs have to be supported.

After receiving the MP from a UE, the small or pico cell reports to the RNC a number of recommended ABSs (for restricting macro cell transmission) for each CRE value in the CRE set of that small or pico cell. The CRE values in the CRE set represent potential RE coverage areas for the cell. These potential values are referred to herein as hypothetical CRE (HCRE) values. The small or pico cell also reports to the RNC DLL information corresponding to UEs present in these potential RE areas of the small or pico cell. The DLL includes load information for the UEs in each of the CRE values of the CRE set of that small or pico cell. The macro cell also reports to the RNC a number of recommended ABSs (for restricting macro cell transmission) for each CRE value in the CRE set of the macro cell. The macro cell also reports to the RNC DLL information indicating load information for the UEs in each of the CRE values of the CRE set of the macro cell.

In an embodiment, each i-th small cell with a current CRE of yᵢ (e.g., 3 dB for a small cell) can perform the following calculations knowing the DLL of the UEs which reported their measurements. The small cell obtains the j-th UE's RE value by UREⱼ=macro CPICH EcNo—small cell CPICH EcNo. For each element of CRE-Set x, with x≦yᵢ it obtains the small cell's recommended ABS (P_ABSᵢ^{x}) density associated to the HCRE value “x” as follows: MPᵢ^{(x)}=∪_{∀j where-3≦URE}_{ⱼ}_{≦x} MPⱼ, DLLᵢ^{(x)}=∪_{∀j where-3≦URE}_{ⱼ}_{≦x} DLLⱼ, P_{ABS}_{ᵢ}_{^{x}}=ABSCal(MPᵢ^{(x)},DLLᵢ^{(x)}). An example of ABSCal function can be

$$ABSCal ( {MP}_{i}^{( x )} , {DLL}_{i}^{( x )} ) = {\sum }_{j} \frac{DLL\_j}{C ( small cell CPICH {EcNo}_{j} )} ,$$

where C(.) is a rate function like C(x)=a log(1+bx), where a and b are constants.

The i-th small cell sends a signal to RNC containing the DLL and the number of the required ABSs corresponding to the different HCRE values in the set that are ≦yᵢ. For HCRE=r1, DLL_i=L1, S1 is the number of ABSs required. The DLL_i can be the number of UEs and/or the aggregate DLL in the corresponding HCRE area. For HCRE=r2, DLL_i=L2, S2 is the number of ABSs required. The same logic is used for any additional HCREs. Sending the DLL_i to RNC is useful since RNC can weigh the ABS density recommendations considering the DLLs sent by small cells.

The macro cell needs to know the CRE-Set for each small cell and the current CRE of each small cell. For each small cell i, the macro cell sends a signal to RNC containing the following information for each HCRE value x>yᵢ. For HCRE=x, DLL for small cell i UEs within yᵢ≦HCRE≦x is Lx, Sx is the number of ABSs required. The macro cell then sends its aggregate DLL to RNC. The RNC then processes all the small and macro cells' reports and decides on the ABS pattern for all cells and on the CRE value for each small cell

For example, FIG. 2 shows different HCRE areas indicated by arrows. In FIG. 2, pico cell A has only one CRE value of 3 dB, and pico cell B has only one CRE value of 6 dB. Pico cell A reports to the RNC the following for the default HCRE of 0 dB: X1 amount of load for the UEs within the boundary of the 0 dB HCRE around pico cell A, and a recommended number of 1 ABS for this CRE. Pico cell A also reports for the HCRE of 3 dB: X1 and X2 amounts of load for the UEs within the boundary of the 3 dB HCRE around pico cell A, and a recommended number of 2 ABSs for this CRE. Since the 3 dB HCRE is larger than and includes the 0 dB HCRE, the load of the 3 dB HCRE is larger and hence the recommended number of ABSs can be larger. Pico cell B also reports to the RNC similar information according to the same logic. The macro cell reports to the RNC for each of the pico cells, a recommended number of ABSs for each HCRE value in the CRE set of the macro cell. For example, for pico cell A< the macro cell reports for HCRE of 6 dB: X3 amount of load of UEs for the UEs within the boundary of the 6 dB HCRE around pico cell A, and a recommended number of 1 ABS for this CRE.

In another example, each of pico cell A and pico cell B has the CRE set {−3, 0, 3}. Pico cell A reports the following: HCRE=−3 dB requires 1 ABS, HCRE=0 dB requires 2 ABSs, and HCRE=3 dB requires 2 ABSs. Pico cell B reports the following: HCRE=−3 dB requires 0 ABS, HCRE=0 dB requires 0 ABSs, and HCRE=3 dB requires 1 ABSs. The reports may be sent without explicitly indicating the corresponding UE load. According to these reports, the RNC may assign 1 ABS and CRE=−3 dB for pico cell A, and 1 ABS and CRE=3 dB for small cell B.

In another example, pico cell A reports the following: HCRE=−3 dB requires 1 ABS with load LA1, HCRE=0 dB requires 1 ABS with load LA2, and HCRE=3 dB requires 2 ABSs with load LA3. Pico cell B reports the following: HCRE=−3 dB requires 1 ABS with load LB1, HCRE=0 dB requires 1 ABS with load LB2, HCRE=3 dB requires 1 ABSs with load LB3, and HCRE=6 dB requires 2 ABSs with load LB4. The macro cell also reports to RNC for pico cell A: HCRE=6 dB requires 1 extra ABS (to the maximum CRE (e.g., 3 dB) report sent by pico cell A) ABS with load LA4. The DLL information is included in these reports. The RNC decides on ABS density and CREs according to the pico cells and macro cell reports.

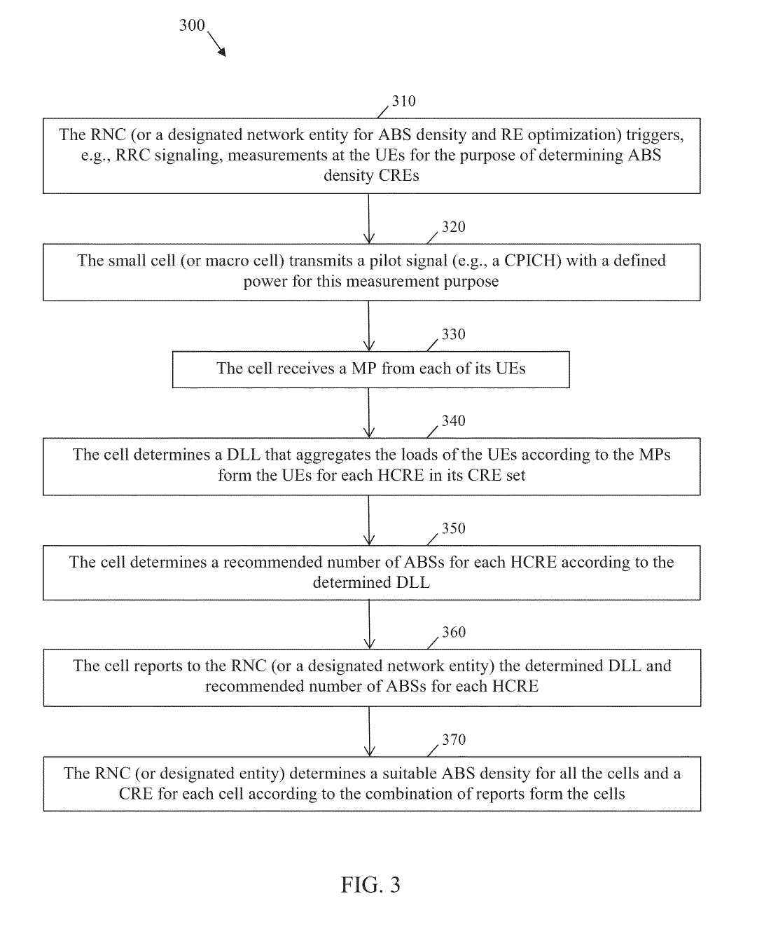

FIG. 3 shows a method 300 for ABS density and RE optimization in heterogeneous networks. The method 300 can be implemented at each small cell and the macro cell. At step 310, the RNC (or a designated network entity for ABS density and RE optimization) triggers, e.g., RRC signaling, measurements at the UEs for the purpose of determining ABS density and CREs. This step can be in response to some network event, such as receiving signaling from a small cell about change in DLL. At step 320, the small cell (or macro cell) transmits a pilot signal (e.g., a CPICH) with a defined power for this measurement purpose. At step 330, the cell receives a MP from each of its UEs. At step 340, the cell determines a DLL that aggregates the loads of the UEs according to the MPs form the UEs for each HCRE in its CRE set. At step 350, the cell determines a recommended number of ABSs for each HCRE according to the determined DLL. At step 360, the cell reports to the RNC (or a designated network entity) the determined DLL and recommended number of ABSs for each HCRE. At step 370, the RNC (or designated entity) determines a suitable ABS density for all the cells and a CRE for each cell according to the combination of reports from the cells.

In another embodiment, the UE reports the MP to the RNC directly, e.g., via RRC signaling. Each small cell also reports to the RNC the DLL and the recommended number of ABS for each HCRE. The macro cell also reports the DLL for each small cell (without a recommended number of ABSs). In yet another embodiment, the UE reports the MP to the RNC directly, e.g., via RRC signaling. The RNC hence sends a function of the UE measurement reports to the small cells and macro cell. Each small cell then reports to the RNC the DLL and the recommended number of ABS for each HCRE. The macro cell also reports, for each small cell, the corresponding DLL and recommended number of ABSs

The DL performance of cell-edge UEs belonging to small cells can be improved using a single frequency dual cell (SFDC) operation. SFDC configured UEs can be simultaneously served by two cells on the same frequency: a serving cell and an assisting serving cell. In HetNet deployment, a small cell can be the serving cell and a macro cell can be the assisting serving cell. Assuming the presence of both SFDC configured UEs and non-SFDC UEs, ABS operation may be required as a technology to serve UEs in the RE area. The SFDC configured UEs, if served in non-ABSs, can affect the macro's load and thus can become a factor in ABS density determination. Therefore, optimization of the ABS pattern can benefit from the knowledge of the DLL and the number of recommended ABSs associated with SFDC configured UEs and non-SFDC UEs, within a HCRE area. In an embodiment that considers SFDC and ABS operations, the RNC takes this information into account in ABS density determination. In this case, instead of one DLL and one ABS density recommendation report per small cell per HCRE value, two reports may be sent: one corresponding to the SFDC configured UEs and the other one corresponding to the remaining UEs.

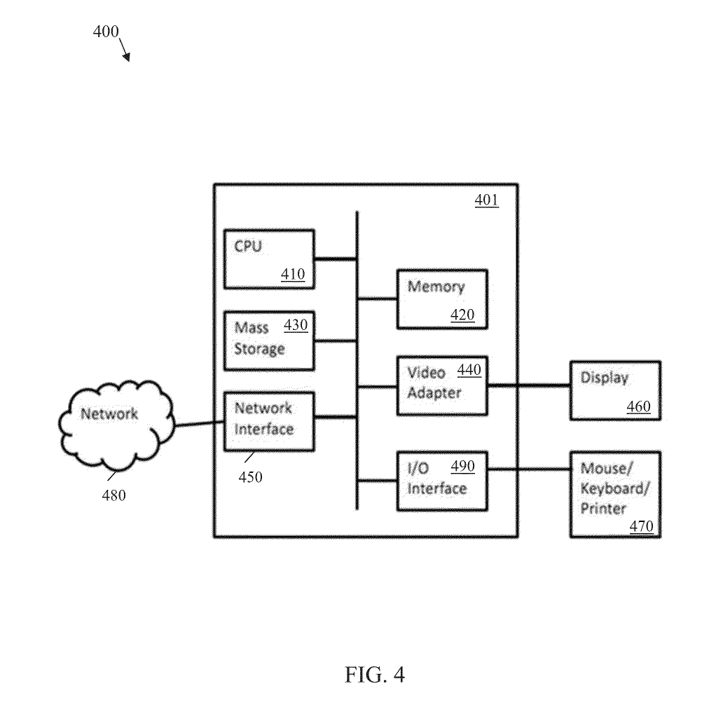

FIG. 4 is a block diagram of an exemplary processing system 400 that can be used to implement various embodiments. The processing system is part of a communications system, for example, at a base station or a UE. The processing system 400 may comprise a processing unit 401 equipped with one or more input/output devices, such as a speaker, microphone, mouse, touchscreen, keypad, keyboard, printer, display, and the like. The processing unit 401 may include a central processing unit (CPU) 410, a memory 420, a mass storage device 430, a video adapter 440, and an Input/Output (I/O) interface 490 connected to a bus. The bus may be one or more of any type of several bus architectures including a memory bus or memory controller, a peripheral bus, a video bus, or the like.

The CPU 410 may comprise any type of electronic data processor. The memory 420 may comprise any type of system memory such as static random access memory (SRAM), dynamic random access memory (DRAM), synchronous DRAM (SDRAM), read-only memory (ROM), a combination thereof, or the like. In an embodiment, the memory 420 may include ROM for use at boot-up, and DRAM for program and data storage for use while executing programs. The mass storage device 430 may comprise any type of storage device configured to store data, programs, and other information and to make the data, programs, and other information accessible via the bus. The mass storage device 430 may comprise, for example, one or more of a solid state drive, hard disk drive, a magnetic disk drive, an optical disk drive, or the like.

The video adapter 440 and the I/O interface 490 provide interfaces to couple external input and output devices to the processing unit. As illustrated, examples of input and output devices include a display 460 coupled to the video adapter 440 and any combination of one or more of a mouse/keyboard/printer 470 coupled to the I/O interface 490. Other devices may be coupled to the processing unit 401, and additional or fewer interface cards may be utilized. For example, a serial interface card (not shown) may be used to provide a serial interface for a printer.

The processing unit 401 also includes one or more network interfaces 450, which may comprise wired links, such as an Ethernet cable or the like, and/or wireless links to access nodes or one or more networks 480. The network interface 450 allows the processing unit 401 to communicate with remote units via the networks 480. For example, the network interface 450 may provide wireless communication via one or more transmitters/transmit antennas and one or more receivers/receive antennas. In an embodiment, the processing unit 401 is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method by a network component in a small cell for determining Almost Blank Subframe (ABS) density and range extension value for small cells in a wireless network, the method comprising:
transmitting a first pilot signal in the small cell;
determining downlink load (DLL) information according to a pair of measurements from each user equipment (UE) served by the small cell, wherein the pair of measurements includes a first measurement of the first pilot signal and a second measurement of a second pilot signal from a macro cell, wherein the macro cell has a higher transmission power than the small cell;
determining a number of ABSs according to the DLL information; and
reporting the DLL information and the number of ABSs to a network entity for selecting ABS density and range extension value for the small cell and the macro cell.

2. The method of claim 1 further comprising receiving a function of the pair of measurements from the network entity.

3. The method of claim 1, wherein the DLL information from each UE is an aggregate function of DL load from each UE served by the small cell.

4. The method of claim 1, wherein determining the DLL information according to the first measurement and the second measurement from each UE served by the small cell comprises determining a DLL value for each hypothetical cell range extension (HCRE) value in a set of cell range extension (CRE) values defined by the wireless network for the small cell.

5. The method of claim 4, wherein determining the number of ABSs according to the DLL information comprises determining, for each HCRE value, a number of ABSs corresponding to the DLL value.

6. The method of claim 5, wherein reporting the DLL information and the number of ABSs to the network entity comprises reporting the DLL value and the number of ABSs for each HCRE value.

7. The method of claim 1, wherein the network entity is a radio network controller (RNC).

8. The method of claim 1, wherein transmitting the pilot signal comprises transmitting a common pilot channel (CPICH) with a defined power.

9. The method of claim 1 further comprising receiving from the network entity an ABS pattern for both the small cell and the macro cell and a CRE value for the small cell, wherein the ABS pattern indicates an ABS with restricted transmission of the macro cell, and wherein the ABS pattern and the CRE are according to the DLL information and the number of ABSs requested by multiple cells including the small cell and the macro cell.

10. A network component in a small cell for determining Almost Blank Subframe (ABS) density and range extension value for small cells in a wireless network, the network component comprising:
at least one processor; and
a non-transitory computer readable storage medium storing programming for execution by the processor, the programming including instructions to:
transmit a first pilot signal in the small cell;
receive a pair of measurements from each user equipment (UE) served by the small cell, wherein the pair of measurements includes a first measurement of the first pilot signal and a second measurement of a second pilot signal from a macro cell, wherein the macro cell has a higher transmission power than the small cell;
determine downlink load (DLL) information according to the first measurement and the second measurement from each UE served by the small cell;
determine a number of ABSs according to the DLL information; and
report the DLL information and the number of ABSs to a network entity for selecting ABS density and range extension value for the small cell and the macro cell.

11. The network component of claim 10, wherein the instructions to determine the DLL information according to the first measurement and the second measurement from each UE served by the small cell include instructions to determine a DLL value for each hypothetical cell range extension (HCRE) value in a set of cell range extension (CRE) values defined by the wireless network for the small cell.

12. The network component of claim 11, wherein the instructions to determine the number of ABSs according to the DLL information include instructions to determine, for each HCRE value, a number of ABSs corresponding to the DLL value.

13. The network component of claim 12, wherein the instructions to report the DLL information and the number of ABSs to the network entity include instructions to report the DLL value and the number of ABSs for each HCRE value.

14. The network component of claim 10, wherein the programming includes further instructions to receive from the network entity an ABS pattern optimized for both the small cell and the macro cell and a CRE optimized individually for the small cell, wherein the ABS pattern indicates an ABS with restricted transmission from the macro cell, and wherein the ABS pattern and the CRE are optimized according to the DLL information and the number of ABSs from multiple cells including the small cell and the macro cell.

15. A method by a network component in a macro cell for determining Almost Blank Subframe (ABS) density and range extension for small cells in a wireless network, the method comprising:
transmitting a first pilot signal in the macro cell;
determining, for each small cell, downlink load (DLL) information according to a pair of measurements from each user equipment (UE) served by each small cell considered in the wireless network, wherein the pair of measurements includes a first measurement of the first pilot signal and a second measurement of a second pilot signal from a small cell, wherein the small cell has a lower transmission power than the macro cell;
determining, for each small cell, a number of ABSs according to the DLL information; and
reporting the DLL information and the number of ABSs for each small cell to a network entity for selecting ABS density and range extension value for each small cell and the macro cell.

16. The method of claim 15 further comprising receiving a function of the pair of measurements from the network entity.

17. The method of claim 15, wherein determining the DLL information according to the first measurement and the second measurement from each UE served by each small cell comprises determining a DLL value for each hypothetical cell range extension (HCRE) value in a set of cell range extension (CRE) values defined by the wireless network for each small cell.

18. The method of claim 17, wherein determining, for each small cell, the number of ABSs according to the DLL information comprises determining, for each HCRE value, a number of ABSs corresponding to the DLL value.

19. The method of claim 18, wherein reporting the DLL information and the number of ABSs for each small cell to the network entity comprises reporting the DLL value and the number of ABSs for each HCRE value.

20. The method of claim 15, wherein the network entity is a radio network controller (RNC).

21. The method of claim 15, wherein transmitting the pilot signal comprises transmitting a common pilot channel (CPICH) with a defined power.

22. The method of claim 15 further comprising receiving from the network entity an ABS pattern optimized for each small cell and the macro cell, wherein the ABS pattern indicates an ABS with restricted transmission from the macro cell, and wherein the ABS pattern and a CRE for each cell are optimized according to the DLL information and the number of ABSs from multiple cells including the small cell and the macro cell.

25. A network component in a macro cell for determining Almost Blank Subframe (ABS) density and range extension value for small cells in a wireless network, the network component comprising:
at least one processor; and
a non-transitory computer readable storage medium storing programming for execution by the processor, the programming including instructions to:
transmit a first pilot signal in the macro cell;
receive a pair of measurements from each user equipment (UE) served by each small cell considered in the wireless network, wherein the pair of measurements includes a first measurement of the first pilot signal and a second measurement of a second pilot signal from a small cell, wherein the small cell has a lower transmission power than the macro cell;
determine, for each small cell, downlink load (DLL) information according to the first measurement and the second measurement from each UE served by the small cell;
determine, for each small cell, a number of ABSs according to the DLL information; and
report the DLL information and the number of ABSs for each small cell to a network entity for selecting ABS density and range extension value for each small cell and the macro cell.

26. The network component of claim 25, wherein the instructions to determine the DLL information according to the first measurement and the second measurement from each UE served by each small cell include instructions to determine a DLL value for each hypothetical cell range extension (HCRE) value in a set of cell range extension (CRE) values defined by the wireless network for each small cell.

27. The network component of claim 26, wherein the instructions to determine, for each small cell, the number of ABSs according to the DLL information include instructions to determine, for each HCRE value, a number of ABSs corresponding to the DLL value.

28. The network component of claim 27, wherein the instructions to report the DLL information and the number of ABSs for each small cell to the network entity include instructions to report the DLL value and the number of ABSs for each HCRE value.

29. The network component of claim 25, wherein the programming further includes instructions to receive from the network entity an ABS pattern optimized for each small cell and the macro cell, wherein the ABS pattern indicates an ABS with restricted transmission from the macro cell, and wherein the ABS pattern and a CRE for each small cell are optimized according to the DLL information and the number of ABSs from multiple cells including the small cell and the macro cell.
